(19) United States
(12) Patent Application Publication
(10) Pub. No.: US 2017/0083950 A1
(43) Pub. Date: Mar. 23, 2017

(54) METHOD AND APPARATUS FOR PROVIDING ATHLETIC DEVELOPMENT INFORMATION TO A USER

(71) Applicants: Michael Grant Fitts, Dallas, TX (US); Steven Clarkson, Burbank, CA (US)

(72) Inventors: Michael Grant Fitts, Dallas, TX (US); Steven Clarkson, Burbank, CA (US)

(21) Appl. No.: 15/269,949

(22) Filed: Sep. 19, 2016

Related U.S. Application Data
(60) Provisional application No. 62/220,031, filed on Sep. 17, 2015.

(51) Int. Cl. G06Q 30/02; G06Q 30/06

(52) U.S. Cl. CPC G06Q 30/0269; G06Q 30/0643; G06Q 30/0277

(57) ABSTRACT

A method and apparatus are provided for pairing a player to an athlete for developing the player. The method for pairing a user to an athlete includes receiving, from a client device, a request to match a user to an athlete. The request identifies a user profile associated with the user. The method also includes retrieving a plurality of athlete profiles and the user profile based on the identification of the user profile associated with the user. The method also includes matching an athlete profile to the user profile. The method also includes, responsive to matching the athlete profile to the user, updating the user profile with data from the matched athlete profile by offering one or more products to the user, wherein the one or more products is based on the data from the matched athlete. The method also includes transmitting the updated user profile to the client device.

### CROSS-REFERENCE TO RELATED APPLICATION AND CLAIM OF PRIORITY

This application claims priority under 35 U.S.C. §119(e) to U.S. Provisional Patent Application No. 62/220,031 filed on Sep. 17, 2016. The above-identified provisional patent application is hereby incorporated by reference in its entirety.

### TECHNICAL FIELD

The present application relates generally to athletic development and, more specifically, to pairing a player to an athlete for developing the player.

### BACKGROUND

Many athletes are increasingly interested in the type of clothing they wear for different sports. For example, a player may want to wear the same cleats in football as a famous football athlete. One of the ways for companies to take advantage of this desire amongst amateur players is to promote their products through sponsorships of famous.

Access to the Internet is growing due to the proliferation of mobile devices, laptops, connected home devices, and the like. One way for amateur players to find out what their favorite athletes are wearing is through Internet searches, or by watching professional games.

### SUMMARY

A method and apparatus are provided for pairing a player to an athlete for developing the player.

An embodiment of this disclosure provides a method for pairing a user to an athlete for developing the user. The method for pairing a user to an athlete includes receiving, from a client device, a request to match a user to an athlete. The request identifies a user profile associated with the user. The method also includes retrieving a plurality of athlete profiles and the user profile based on the identification of the user profile associated with the user. The method also includes matching an athlete profile to the user profile. The method also includes, responsive to matching the athlete profile to the user, updating the user profile with data from the matched athlete profile by offering one or more products to the user, wherein the one or more products is based on the data from the matched athlete. The method also includes transmitting the updated user profile to the client device.

Another embodiment of this disclosure provides an apparatus for pairing a user to an athlete for developing the user. The apparatus includes a memory element and a processing device coupled to the memory element. The memory element is configured to store a plurality of athlete profiles and a user profile. The processing device is configured to receive, from a client device, a request to match a user to an athlete, wherein the request identifies the user profile associated with the user. The processing device is also configured to retrieve the plurality of athlete profiles and the user profile based on the identification of the user profile associated with the user. The processing device is also configured to match an athlete profile from among the plurality of athlete profiles to the user profile. The processing device is also configured to, responsive to matching the athlete profile to the user, update the user profile with data from the matched athlete profile by offering one or more products to the user, wherein the one or more products is based on the data from the matched athlete. The processing device is also configured to send the updated user profile to the client device.

Yet another embodiment of this disclosure provides a non-transitory processor-readable medium storing a plurality of computer-executable instructions that when executed by a processor cause the processor to receive, from a client device, a request to match a user to an athlete, wherein the request identifies the user profile associated with the user. The instructions also cause the processor to retrieve the plurality of athlete profiles and the user profile based on the identification of the user profile associated with the user. The instructions also cause the processor to match an athlete profile from among the plurality of athlete profiles to the user profile. The instructions also cause the processor to, responsive to matching the athlete profile to the user, update the user profile with data from the matched athlete profile by offering one or more products to the user, wherein the one or more products is based on the data from the matched athlete. The instructions also cause the processor to send the updated user profile to the client device

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example computing system according to this disclosure;

FIGS. 2 and 3 illustrate example devices in a computing system according to this disclosure;

FIG. 4 illustrates a pairing system according to this disclosure;

FIG. 5 illustrates a process for matching a user to an athlete according to this disclosure;

FIG. 6 illustrates a process for updating a user profile according to this disclosure;

FIGS. 7A-7B illustrate an example display of a gear profile page according to this disclosure;

FIG. 8 illustrates an example display of a team page according to this disclosure; and

FIG. 9 illustrates a process for providing a user profile to a user according to this disclosure.

### DETAILED DESCRIPTION

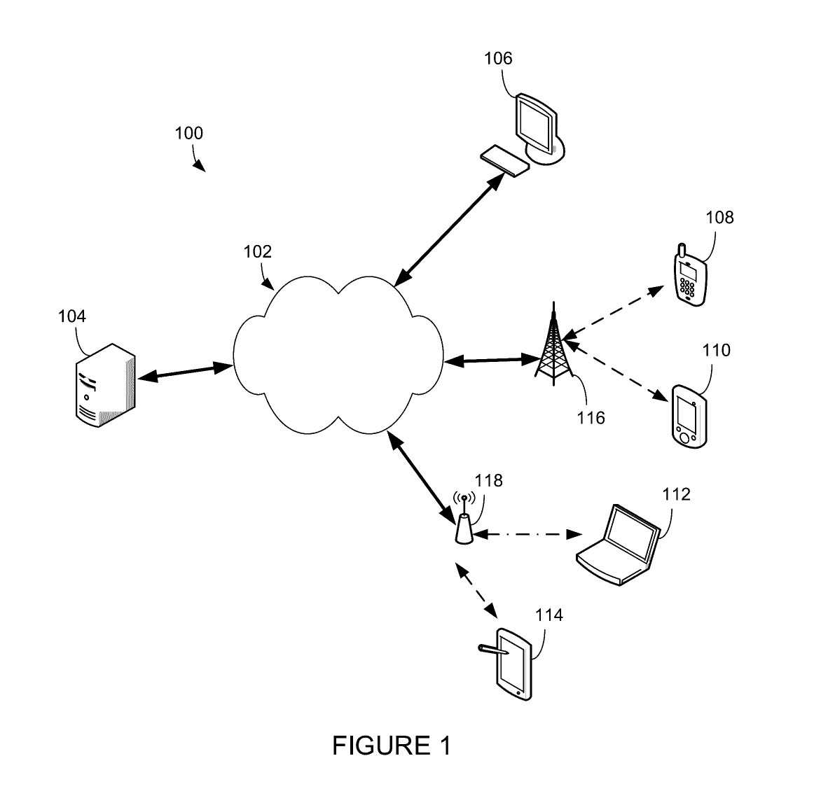

FIGS. 1 through 6, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used in describing various embodiments of the present disclosure are only examples for describing a specific embodiment but do not limit the various embodiments of the present disclosure. Singular forms are intended to include plural forms unless the context clearly indicates otherwise.

An electronic device according to various embodiments of the present disclosure may be a device including a projection function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HHD) such as electronic glasses, electronic clothes, and electronic bracelet, an electronic necklace, an electronic appcessary, an electronic tattoo, and a smart watch.

According to some embodiments, the electronic device may be a smart home appliance having a projection function. The smart home appliance may include at least one of a TeleVision (TV), a Digital Video Disk (DVD) player, mirror, an audio player, an air conditioner, a cleaner, an oven, a microwave oven, a washing machine, an air cleaner, a set-top box, a TV box, game consoles, an electronic dictionary, an electronic key, a camcorder, and an electronic frame.

Hereinafter, an electronic device according to various embodiments of the present disclosure will be described with reference to the accompanying drawings. The term “user” used in various embodiments may refer to a person who uses an electronic device or a device that uses an electronic device.

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between at least one server 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

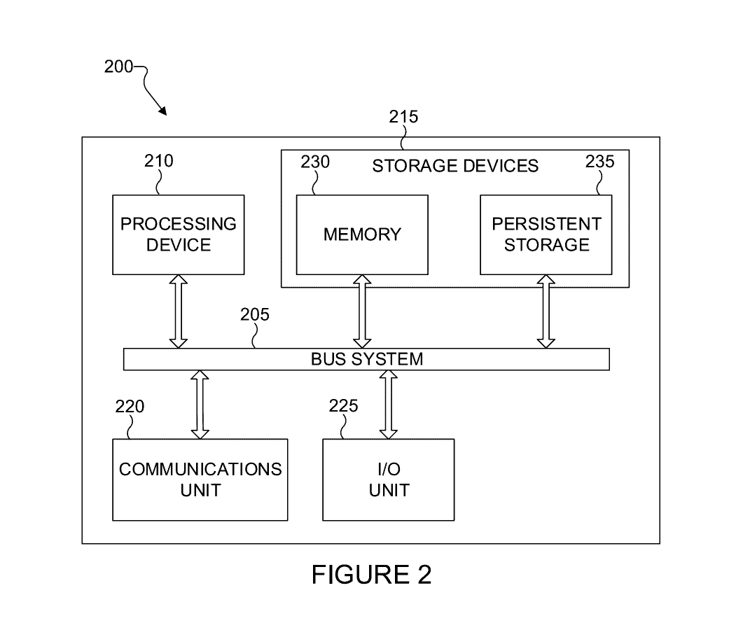

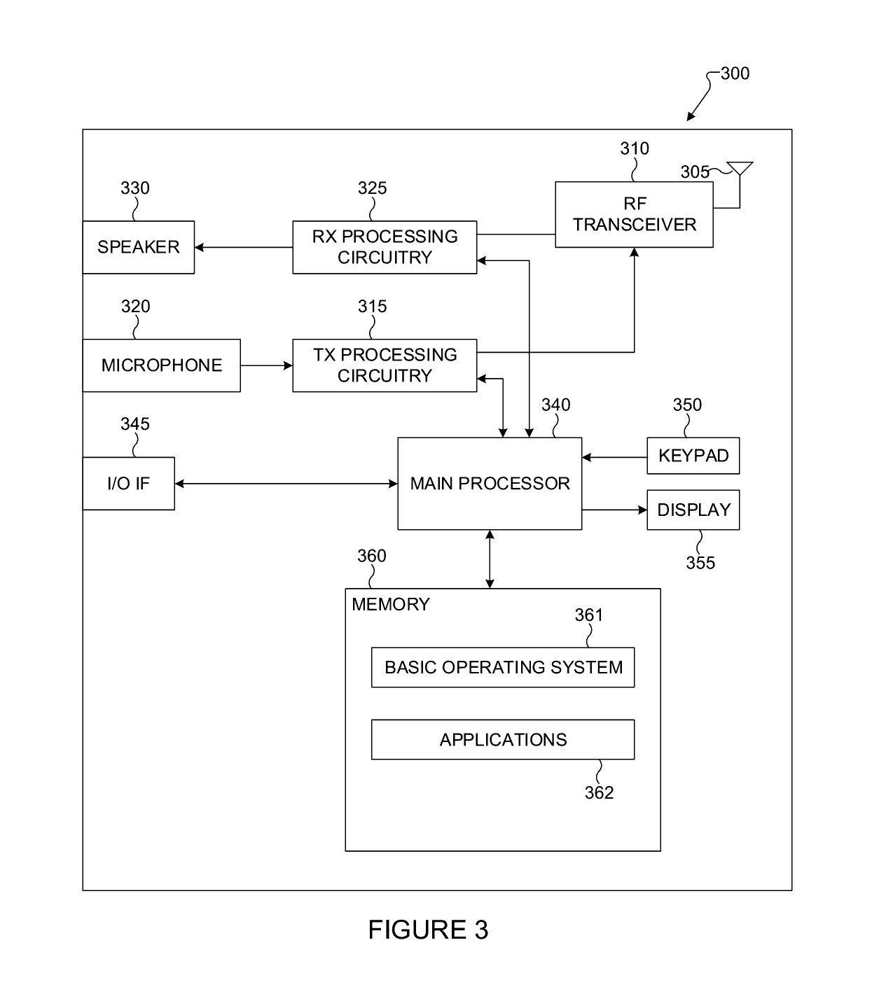

FIGS. 2 and 3 illustrate example devices in a computing system according to this disclosure. In particular, FIG. 2 illustrates an example server 200, and FIG. 3 illustrates an example client device 300. The server 200 could represent the server 104 in FIG. 1, and the client device 300 could represent one or more of the client devices 106-114 in FIG. 1.

As shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing the server 104 of FIG. 1, the same or similar structure could be used in one or more of the client devices 106-114. For example, a laptop or desktop computer could have the same or similar structure as that shown in FIG. 2.

As shown in FIG. 3, the client device 300 includes an antenna 305, a radio frequency (RF) transceiver 310, transmit (TX) processing circuitry 315, a microphone 320, and receive (RX) processing circuitry 325. The client device 300 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the client device 300. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from external devices or an operator. The main processor 340 is also coupled to the I/O interface 345, which provides the client device 300 with the ability to connect to other devices such as laptop computers and handheld computers. The I/O interface 345 is the communication path between these accessories and the main processor 340.

The main processor 340 is also coupled to the keypad 350 and the display unit 355. The operator of the client device 300 can use the keypad 350 to enter data into the client device 300. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

One or more embodiments of this disclosure recognize and take into account the difficulty for companies that sell athletic gear to reach players who want to use athletic gear (“gear”) that their favorite athletes wear. The embodiments of this disclosure provide a system to use athlete-user matches to present the user with access to gear styles used by the athlete so users can take the associated suggestions as a jumping off point to build their own ensemble of gear. The user can use a blank character on their mobile device and fill it out with cleats, socks, shorts/pants, shirts, helmets, gloves, and the like. The user can also link or follow other friends' profiles on an application 362 that can lead to more access to gear.

In one example embodiment, if a friend group can fill out a position by position team, they could increase their chances to win their self-chosen fantasy look. Things like chances to meet their athlete matches or win free gear could be used to entice app usage. Gear could be clickable and could be purchased either directly through the app or through the gear sellers' retail page. One or more example embodiments can provide a fun fantasy look creator that allows users to get excited about gear by making the user feel closer to professional status.

As used herein, there is references to “user,” “player,” “athlete,” “amateur,” and “professional.” Each of these terms can indicate a person who is utilizing the system as described herein. For example, a player can use the system to find athletes, and an athlete can use the system to find other athletes or players. Each of the players, athletes, amateurs, and professionals can be a user. As used herein, a player and amateur can be a user that is looking to be matched with another user, for example an athlete or professional.

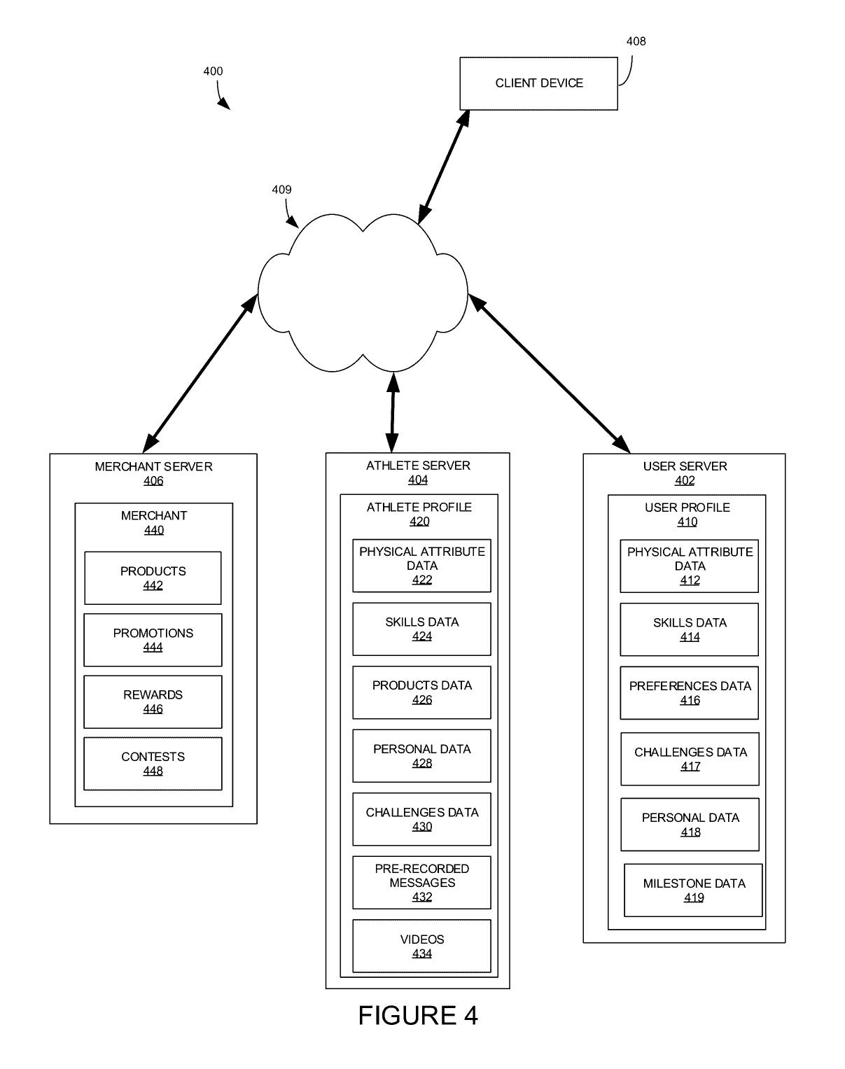

FIG. 4 illustrates a pairing system 400 according to this disclosure. The embodiment of the system 400 shown in FIG. 4 is for illustration only. Other embodiments of the system 400 could be used without departing from the scope of this disclosure.

In particular, FIG. 4 illustrates an example user server 402, athlete server 404, merchant server 406, and client device 408 connected through network 409. Each of the servers 402-406 could represent the server 104 in FIG. 1, and the client device 408 could represent one or more of the client devices 106-114 in FIG. 1.

In FIG. 4, a user server 402 can include one or more user profiles. Each user profile 410 can be associated with a user. A user can also be referred to herein as a player. A user profile 410 can be associated with the user by a unique identifier such as, but not limited to an email address or telephone number. Each user profile 410 is also able to pair with an athlete. An athlete can be a professional athlete, Olympic athlete, or other famous/celebrity athlete. When the user profile 410 is paired with an athlete, the user profile 410 can also include information from an athlete profile 420. Each user profile 410 includes physical attribute data 412. The physical attribute data 412 can include, but is not limited to, height, weight, age, wingspan, arm length, leg length, and the like. Each user profile 410 can also include skills data 414. The skills data 414 can include, but is not limited to, 40-yard dash time, bench press, vertical jump distance, broad jump distance, twenty yard shuttle time, three cone drill time, 60-yard shuttle time, position-specific drill metrics, three-quarter-court sprint time, lane agility time, modified event time and the like.

Each user profile 410 can also include preferences data 416. The preferences data 416 can include, but is not limited to, position preferences, school preferences, product preferences, and the like. Each user profile 410 can also include challenges data 417. The challenges data 417 can include challenges for the users provided by the athletes. Each user profile 410 can also include personal data 418. The personal data 418 can include, but is not limited to, city information, state information, school information, work information, and the like. Each user profile 410 is also able to pair with an athlete. Each user profile 410 can also include milestone data 419. The milestone data 419 can include milestones for the user such as different results for any skills in the skills data 414, awards, accomplishments, and the like.

An athlete server 404 can include one or more athlete profiles. An athlete profile 420 can be associated with an athlete by name. Each athlete profile 420 is also able to be paired with one or more users. Each athlete profile 420 includes physical attribute data 422. Physical attribute data 422 can include, but is not limited to, height, weight, age, wingspan, arm length, leg length, and the like. Each physical attribute data 422 can have multiple entries for different ages or stages of the athlete's career. Each athlete profile 420 can also include skills data 424. The skill data 424 can include, but is not limited to, 40-yard dash time, bench press, vertical jump distance, broad jump distance, twenty yard shuttle time, three cone drill time, 60-yard shuttle time, position-specific drill metrics, three-quarter-court sprint time, lane agility time, modified event time and the like. Each skill data 424 can have multiple entries for different ages or stages of the athlete's career. Each athlete profile 420 can also include products data 426. The products data 426 can include products or services that the athlete uses or recommends.

Each athlete profile 420 can also include personal data 428. The personal data 428 can include, but is not limited to, city information, state information, school information, hometown information, team information, personal website, social media information, and the like. Each athlete profile 420 can also include challenges data 430. The challenges data 430 can include challenges for the users that the athlete is paired. The challenges can be further delineated by age, position, difficulty, and the like. Each athlete profile 420 can also include pre-recorded messages 432. The pre-recorded messages 432 can include messages for users to be delivered when certain user milestones are reached. Each athlete profile 420 can also include videos 434. The videos 434 can include highlight for viewing by the user.

A merchant server 406 can include one or more merchants 440, each merchant with one or more products 442. The products 442 can be apparel, gear, equipment, and gym memberships, and other products or services that athletes in system 400 use. Each merchant 440 can upload the products 442 into the merchant server 406. When a product is loaded into the merchant server 406, it is able to be retrieved and sent to a user. The user can purchase the product using system 400. Merchant server 406 can also include promotions 444, rewards 446, and contests 448. A promotion can be a discount or other offer for users. The promotions 444 can be contingent upon completion of certain milestones or challenges. A reward can be a free offer for the users. The rewards 446 can be contingent upon completion of certain milestones or challenges. Athletes can select certain products or services to recommend to the users. In on example, the athlete can receive a commission on the sale of any products or services the athlete recommends.

Although FIG. 4 illustrates one example of a pairing system 400, various changes may be made to FIG. 4. For example, the system 400 could include any number of each component in any suitable arrangement, such as any combination of servers 402, 404, and 406 being a single server. In general, pairing systems come in a wide variety of configurations, and FIG. 4 does not limit the scope of this disclosure to any particular configuration. The information provided by system 400 can be sent to a display of a client device, such as display 355 as shown in FIG. 3, and displayed as part of an application, such as application 362 as shown in FIG. 3. While FIG. 4 illustrates one operational environment in which various features disclosed in this patent document can be used, these features could be used in any other suitable system.

In one example embodiment, the system is configured to match a user to an athlete then pair the user to the athlete for tracking progress of the user and providing suggestions of products, challenges, milestones, estimates of future capabilities and the like. The user can be matched to the athlete as a function of the athlete and user parameters included in the preferences data 416. The parameters can be physical attributes, sports related, position related, school related, common interests, and the like. For example, a user with a certain set of physical attributes could be matched to an athlete with a similar or same set of physical attributes. In one example, age can be taken into account to match the user of a certain age to recorded attributes of an athlete when the athlete was of the same age. The profile of the athlete can include physical attributes for more than one age, or can be based on area of career, such as high school, college, professional and the like. The user and athlete can be matched on any number of parameters from one parameter or all parameters.

The user can also select which parameters to use through a filtering process or opt to select an athlete directly. In one example, the athlete could select to get matched based on parameters including a desired college, sport, position, and physical attributes. In this example, the athlete would be selected that attended the desired college at some point and played the selected sport and position. The athlete with the closest physical attributes would be matched and paired. In yet another example, if the system could offer a list of top matches for user selection. The list could include matches within the parameters set by the user as well as matches that closely match the physical attributes of the user. In this example, the user could see suggestions of other positions or potentially sports that athletes with similar attributes have succeeded.

In one example embodiment, the system is configured to provide a series of predetermined training challenges to a user as included in the challenges data 417 and 430. The challenges can be uploaded or set by an athlete and linked to the user profile. The challenges for each user can be determined by the athlete that the user is paired. The challenges can be periodic, such as daily, weekly, monthly and the like. A user can document progress on each challenge and share the progress through messaging or social media. The user can be notified by the challenges through a push alert notification and/or the challenges could be located in a specific section of the application. Some athletes may opt to follow users on social media that complete a certain number of challenges or specific challenges. The athletes may also follow the users if the user purchases a certain amount of products associated with the athlete.

In one example embodiment, each user can have milestones that can be predetermined or set as a function of the user parameters and profile. The athlete server can include pre-recorded messages from different athletes to be sent to a user upon completion of different milestones. For example, if a user reaches a certain weightlifting milestone, an athlete paired with the user could have a message recorded congratulating the user on the milestone.

In one example embodiment, merchants can provide promotions based on the challenges or milestones. The promotions could require proof of completion, and that proof could be required to be uploaded to social media. In one example embodiment, the system will request the users to upload pictures, videos, and reviews of products and training methods. The user can receive discounts, promotions, entries into giveaway contests, and the like when rating products such as training apparel.

The athletes can provide tips and suggestions to paired users. These tips and suggestions can include tips on healthy nutrition (including sponsored products), advice on preparing for an upcoming season or game, how to stay healthy, apparel and gear for varying levels of skill level, age, and affordability. The athlete can include links to different sites including the athlete's web site and/or social media sites. The links can also include links to the athlete's team schedule and ticket options with discounts for users meeting required challenges or milestones.

In an example embodiment, over time, the user data on the user profile will change. The system can provide suggestions for different athletes to pair with the user as the user data changes. The system may also provide expected changes to the user profile based on aggregated data from other user profiles. For example, given a user's physical attributes, the system can determine future skill test scores and times. These expected changes can affect a position the user may be most suited to play and provide guidance during player development.

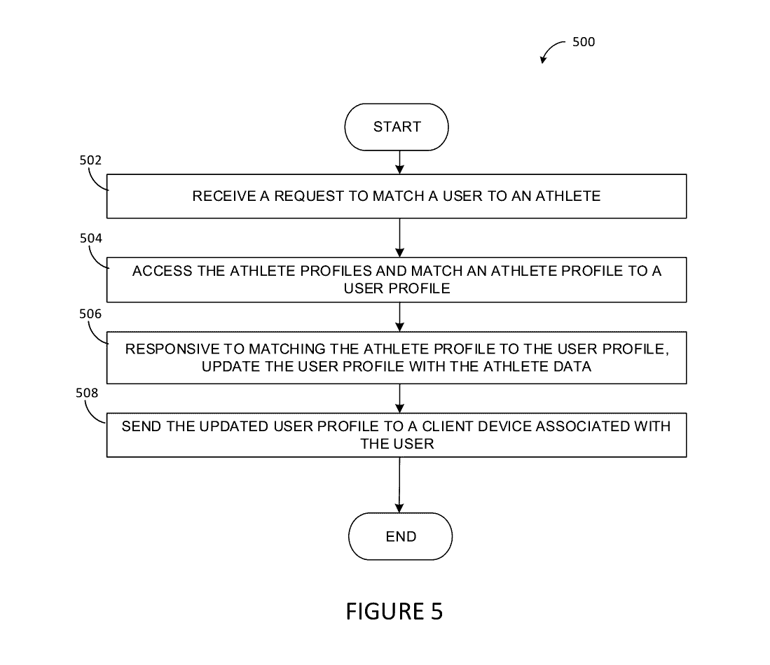

FIG. 5 illustrates a process 500 for matching a user to an athlete according to this disclosure. The process 500 illustrated in FIG. 5 is for illustration only, and can be executed by one or more components as described in FIGS. 1-4, such as a controller, processor, and/or processing circuitry of a server. However, the operations of process 500 come in a wide variety of configurations, and FIG. 5 does not limit the scope of this disclosure to any particular implementation of process 500.

At operation 502, a server may receive a request to match a user to an athlete. The request can be part of a signup or profile creation process. The request can also include the different parameters to be included during matching. The parameters can be used to filter the potential athletes for matching. For example, the parameters can include, but are not limited to, a school, team, position, physical attributes, and the like.

At operation 504, the server can access the athlete profiles and match an athlete profile to a user profile. In one example the server could use a heuristic to identify an athlete match. The heuristic could weight some parameters greater than other parameters. For example, position may be weighted more than school. In another example, the user can select a weighting of each parameter. The user may be more interested in an athlete from the same high school or college than a position of the user. The weights applied to the parameters can change dynamically over time based on the continual development of the users. For example, if the system determines that users who are paired with athletes from a similar hometown, then the system may weight this parameter more greatly. Each user can select to request a new match if they are unsatisfied with a previous match. This request could be used to obtain information related to the previous weights for the previous match. The system could also obtain feedback from the user when a new match is requested.

In one embodiment, the athlete with the greatest number of matched attributes is matched to the user. In another embodiment, a score is given for each athlete with the player based on the weighted parameters and the athlete with the greatest score is paired.

At operation 506, responsive to matching the athlete profile to the user profile, the system can update the user profile with the athlete data. The athlete data can include athlete products and challenges. At operation 508, the system sends the updated user profile to a client device associated with the user.

In one example embodiment, vendors can provide different promotions for merchandise (products). The promotions can be based on the athlete challenges or user challenges. For example, an athlete can provide a challenge of a specific training routine (such as running five miles). The application on the client device can track training data and update a user's progress for a challenge. Upon completion of the challenge, the promotion may become available for the user for the purchase of a product at a discount and the like. In another example, a vendor may offer a promotion if a user can form a team. In this example, if a user links to teammates and those teammates (friends) join a team page and fill different positions on a team, the vendor's promotion may become available and the user and/or each team member may be able to purchase products at a discount. In another example, to unlock the promotions, each member of the team may have to create a profile with a specific product such as, for example, a specific brand of cleats.

In one or more various embodiments, the promotions can rewards or other prizes. For example, in one embodiment, a team may obtain tickets to a sporting event or meet their favorite player based on completing a challenge. In other embodiments, the user may obtain different promotions by completing a team or getting each team member to outfit a profile with a specific brand.

Although FIG. 5 illustrates an example process for matching a user to an athlete, various changes could be made to FIG. 5. For example, while shown as a series of steps, various steps in each figure could overlap, occur in parallel, occur in a different order, or occur multiple times.

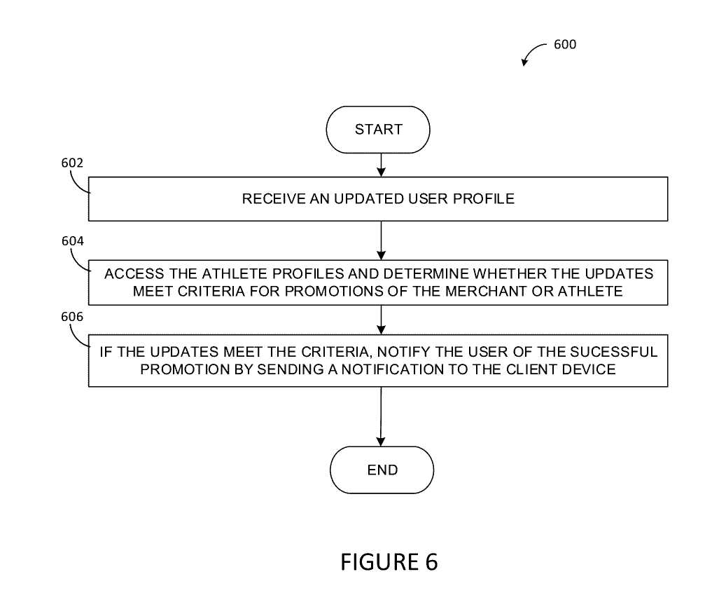

FIG. 6 illustrates a process 600 for updating a user profile according to this disclosure. The process 600 illustrated in FIG. 6 is for illustration only, and can be executed by one or more components as described in FIGS. 1-4, such as a controller, processor, and/or processing circuitry of a server. However, the operations of process 600 come in a wide variety of configurations, and FIG. 5 does not limit the scope of this disclosure to any particular implementation of process 600.

At operation 602, a server may receive an updated user profile. The updates can be part of physical attribute data, skills data, preferences data, challenges data, personal data, or milestone data.

At operation 604, the server can access the athlete profiles and determine whether the updates meet criteria for promotions of the merchant or athlete. In one example the promotions can also be rewards, contests, or requirements for an athlete to follow a user on social media. If the updates meet the criteria, at operation 606, the server can notify the user of the successful promotion by sending a notification to the client device.

Although FIG. 6 illustrates an example process for updating a user profile, various changes could be made to FIG. 6. For example, while shown as a series of steps, various steps in each figure could overlap, occur in parallel, occur in a different order, or occur multiple times.

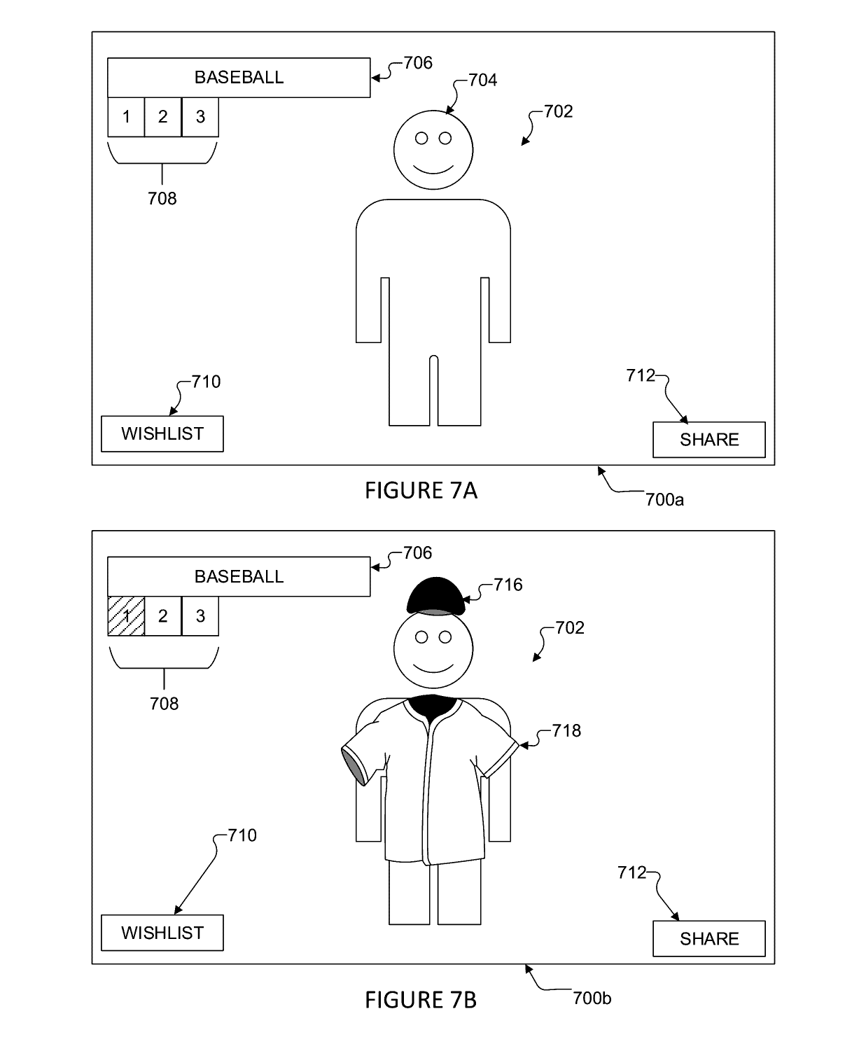

FIGS. 7A-7B illustrate an example display 700 of a gear profile page according to this disclosure. The embodiment of the display 700 shown in FIG. 7 is for illustration only. For example, the example used in FIG. 7 illustrates the use of a baseball theme; however in other embodiments, other sports may be used such as, but not limited to, football, soccer, lacrosse, and the like. Other embodiments of a gear profile page could be used without departing from the scope of this disclosure.

In FIG. 7A, the display 700a includes a player 702 with a face 704. In one example, the player 702 and face 704 can be generic representations. In another example, the player 702 body and/or face 704 can be depictions of a user of a mobile device and selected through a photo gallery or taken with a camera on the mobile device or the user can use a picture of an athlete. In one example embodiment, the player 702 can be an avatar selected by a user. The avatar can be a depiction of a generic virtual person, or can be a photograph of the user.

The user can select a sport through a tab 706 and each sport can have different profiles 708. The sports selected on tab 706 can include all possible sports, or can be narrowed by the user through a setup process. As shown here, there are only three profiles 708, however, more or less profiles can be used and shown in other examples. Different sports can also have differing numbering of profiles.

The display 700a can also include a wish list 710 and/or share tab 712. The wish list 710 allows a user to quickly access all desirable merchandise (also referred to as gear). An item of gear or merchandise can be added to the wish list 710 through user selection. The share tab 712 can allow a user to share a profile with a friend or post a profile to social media.

In FIG. 7B, profile 1 is selected from the profiles 708. This profile is a baseball profile and shows a partial selection of gear including hat 716 and jersey 718. The user can add additional gear such as cleats, socks, armbands, pants, and the like. Each of the items of gear 716 and 718 can be selectable through a click, gesture on a touch screen, or through physiological selection such as eye tracking where the user focuses on the item of gear.

Once selected, the item of gear can link the user to a purchase page, either within the application or to an Internet portal for purchasing. The selection can also provide the user with a number of options, such as sharing that piece of gear with another user, removing the gear from the player 702, or changing colors.

Although FIG. 7 illustrates one example of a gear profile page, various changes may be made to FIG. 7. For example, the gear profile page could include additional suitable options. In general, gear profile pages come in a wide variety of configurations, and FIG. 7 does not limit the scope of this disclosure to any particular configuration. The information for display 700 can be sent to a display of a client device, such as display 355 as shown in FIG. 3, and displayed as part of an application. While FIG. 7 illustrates one operational environment in which various features disclosed in this patent document can be used, these features could be used in any other suitable system.

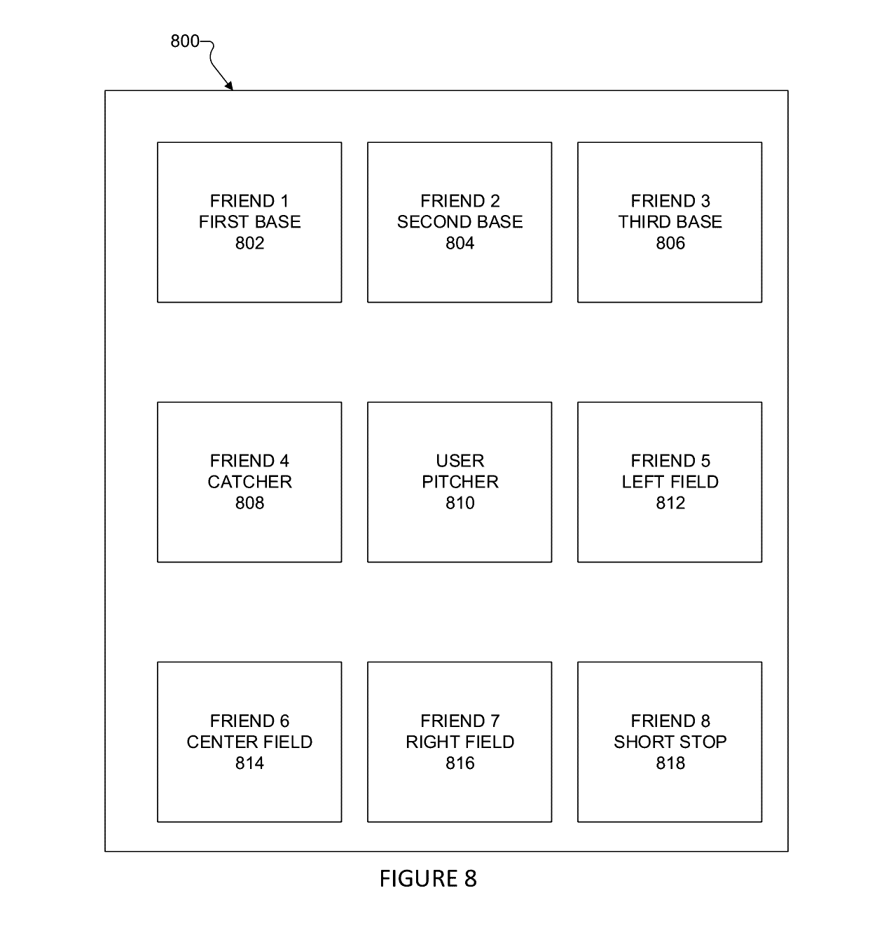

FIG. 8 illustrates an example display 800 of a team page according to this disclosure. The embodiment of the display 800 shown in FIG. 8 is for illustration only. For example, the example used in FIG. 8 illustrates the use of a baseball theme; however in other embodiments, other sports may be used such as, but not limited to, football, soccer, lacrosse, and the like. Other embodiments of a team page could be used without departing from the scope of this disclosure.

In FIG. 8, the display 800 includes positions 802-818. Each position can be labeled, such as in this example as first base, second base, third base, and the like. As depicted in FIG. 8, the positions are listed in a block diagram format. In other example embodiments, the positions can be depicted in other formats, such as shown on a field for the sport with each position being correctly placed on the field.

The user can invite friends to join the team page. As shown in FIG. 8, the user has taken position 810, the pitcher, while the rest of the positions 802-808 and 812-818 are taken by friends. The user can select friends through email, social network, phone number, and/or through the application. In one example embodiment, the user can send invitations to join a team page that the user creates.

In one example, each friend can select a specific profile to post to the team page. Display 800 can also optionally include a team chat board for comments and discussion on the selected gear for the team and each player.

In one or more embodiments, the team page can be used by vendors to provide promotions, discounts, or challenges to the user or team as discussed in FIG. 4. For example, a vendor may offer a discount to the team for a specific piece of gear, such as a hat, if each member of the team selects a specific brand or style.

Similarly to the matching process performed in FIG. 5, a team can be paired with another team. The system can take into account the attributes of all players of the team as well as and specific filtering that the team desires to select a matched team.

Although FIG. 8 illustrates one example of a team page, various changes may be made to FIG. 8. For example, the team page could include additional suitable options. In general, team pages come in a wide variety of configurations, and FIG. 8 does not limit the scope of this disclosure to any particular configuration. The information for display 800 can be sent to a display of a client device, such as display 355 as shown in FIG. 3, and displayed as part of an application. While FIG. 8 illustrates one operational environment in which various features disclosed in this patent document can be used, these features could be used in any other suitable system.

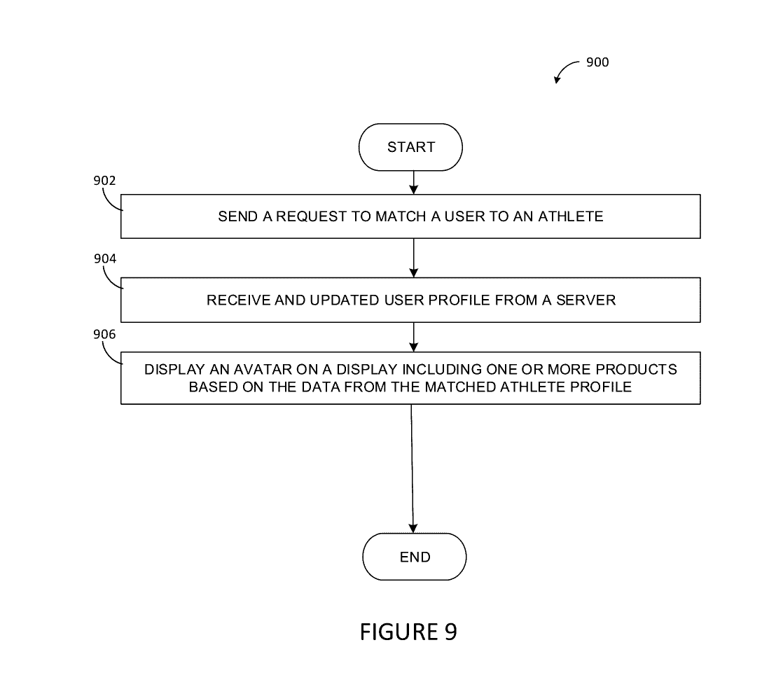

FIG. 9 illustrates a process 900 for providing a user profile to a user according to this disclosure. The process 9009 illustrated in FIG. 9 is for illustration only, and can be executed by one or more components as described in FIGS. 1-4 and 7A-8, such as a controller, processor, and/or processing circuitry of a server. However, the operations of process 900 come in a wide variety of configurations, and FIG. 9 does not limit the scope of this disclosure to any particular implementation of process 900.

At operation 902, a client device can send, to a server, a request to match a user to an athlete. In one example, the request identifies a user profile associated with the user. The identification can be done through email, phone number, unique identifier, and the like.

At operation 904, the client device can receive an updated user profile from the server. In one example, the user profile is matched at the server to an athlete profile from among a plurality of athlete profiles. The user profile can include data from the matched athlete profile. The data can include challenges, promotions, goals, statistics, and the like. In one embodiment, the request to match includes a specific athlete that the user would like to select. In this example, the user is matched to that athlete. In another example, the user simply filters the potential athletes for selection through a selection of different parameters such as, but not limited to, school, team, physical attributes, position, and the like.

At operation 906, the client device can display an avatar on a display including one or more products based on the data from the matched athlete. The one or more products can be related to the matched athlete profile.

Although FIG. 9 illustrates an example process for providing a user profile to a user, various changes could be made to FIG. 9. For example, while shown as a series of steps, various steps in each figure could overlap, occur in parallel, occur in a different order, or occur multiple times.

Although the figures illustrate different examples of a server, various changes may be made to the figures. For example, the server can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. §112(f).

What is claimed is:

1. A method for pairing a user to an athlete, the method comprising:
receiving, from a client device, a request to match the user to the athlete, wherein the request identifies a user profile associated with the user;
retrieving a plurality of athlete profiles and the user profile based on the identification of the user profile associated with the user;
matching an athlete profile from among the plurality of athlete profiles to the user profile;
responsive to matching the athlete profile to the user, updating the user profile with data from the matched athlete profile by offering one or more products to the user, wherein the one or more products is based on the data from the matched athlete; and
sending the updated user profile to the client device.

2. The method of claim 1, wherein matching the athlete profile to the user profile comprises:
identifying one or more athlete attributes of each of the plurality of athlete profiles;
identifying one or more user attributes of the user profile; and
matching the user profile to the athlete profile with a greatest number of similar attributes.

3. The method of claim 1, further comprising:
receiving, from the client device, a selection of a filter for the plurality of athlete profiles, wherein the filter is applied during the matching the athlete profile to the user profile.

4. The method of claim 1, wherein updating the user profile with the data from the matched athlete profile comprises:
identifying one or more of brand sponsorships, challenges, and gear; and
including the one or more of the brand sponsorships, the challenges, and the gear into the user profile.

5. The method of claim 1, further comprising:
receiving a promotion from a vendor for a set of merchandise based on the use profile;
transmit the promotion to the client device associated with the user.

6. The method of claim 1, further comprising:
establishing a team page for a plurality of users including the user;
receiving a promotion from a vendor for a set of merchandise based on the team page;
transmit the promotion to the client device associated with the user.

7. An apparatus, comprising:
a memory element configured to store a plurality of athlete profiles and a user profile; and
a processing device coupled to the memory element, the processing device configured to:
receive, from a client device, a request to match a user to an athlete, wherein the request identifies the user profile associated with the user;
retrieve the plurality of athlete profiles and the user profile based on the identification of the user profile associated with the user;
match an athlete profile from among the plurality of athlete profiles to the user profile;
responsive to matching the athlete profile to the user, update the user profile with data from the matched athlete profile by offering one or more products to the user, wherein the one or more products is based on the data from the matched athlete; and
send the updated user profile to the client device.

8. The apparatus of claim 7, wherein matching the athlete profile to the user profile comprises:
identifying one or more athlete attributes of each of the plurality of athlete profiles;
identifying one or more user attributes of the user profile; and
matching the user profile to the athlete profile with a greatest number of similar attributes.

9. The apparatus of claim 7, further comprising:
receiving, from the client device, a selection of a filter for the plurality of athlete profiles, wherein the filter is applied during the matching the athlete profile to the user profile.

10. The apparatus of claim 7, wherein updating the user profile with the data from the matched athlete profile comprises:
identifying one or more of brand sponsorships, challenges, and gear;
include the one or more of the brand sponsorships, the challenges, and the gear into the user profile.

11. The apparatus of claim 7, further comprising:
receiving a promotion from a vendor for a set of merchandise based on the use profile;
transmit the promotion to the client device associated with the user.

12. The apparatus of claim 7, further comprising:
establishing a team page for a plurality of users including the user;
receiving a promotion from a vendor for a set of merchandise based on the team page;
transmit the promotion to the client device associated with the user.

13. A non-transitory processor-readable medium storing a plurality of computer-executable instructions that when executed by a processor cause the processor to:
receive, from a client device, a request to match a user to an athlete, wherein the request identifies a user profile associated with the user;
retrieve a plurality of athlete profiles and the user profile based on the identification of the user profile associated with the user;
match an athlete profile from among the plurality of athlete profiles to the user profile;
responsive to matching the athlete profile to the user, update the user profile with data from the matched athlete profile by offering one or more products to the user, wherein the one or more products is based on the data from the matched athlete; and
send the updated user profile to the client device.

14. The non-transitory processor-readable medium of claim 13, wherein matching the athlete profile to the user profile comprises:
identifying one or more athlete attributes of each of the plurality of athlete profiles;
identifying one or more user attributes of the user profile; and
matching the user profile to the athlete profile with a greatest number of similar attributes.

15. The non-transitory processor-readable medium of claim 13, further comprising:
receiving, from the client device, a selection of a filter for the plurality of athlete profiles, wherein the filter is applied during the matching the athlete profile to the user profile.

16. The non-transitory processor-readable medium of claim 13, wherein updating the user profile with the data from the matched athlete profile comprises:
identifying one or more of brand sponsorships, challenges, and gear;
include the one or more of the brand sponsorships, the challenges, and the gear into the user profile.

17. The non-transitory processor-readable medium of claim 13, further comprising:
receiving a promotion from a vendor for a set of merchandise based on the use profile;
transmit the promotion to the client device associated with the user.

18. The non-transitory processor-readable medium of claim 13, further comprising:
establishing a team page for a plurality of users including the user;
receiving a promotion from a vendor for a set of merchandise based on the team page;
transmit the promotion to the client device associated with the user.

19. A method for providing a product selection, the method comprising:
sending, to a server, a request to match a user to an athlete, wherein the request identifies a user profile associated with the user;
receiving an updated user profile from the server, wherein the user profile was matched to an athlete profile from among a plurality of athlete profiles, and wherein the user profile includes data from the matched athlete profile;
displaying an avatar on a display including one or more products based on the data from the matched athlete profile.

20. The method of claim 19, wherein the avatar is a photograph of the user.
